(19) United States
(12) Patent Application Publication
(10) Pub. No.: US 2009/0025171 A1
(43) Pub. Date: Jan. 29, 2009

(54) Arrangement for mounting a single-piece windscreen wiper arm on a driving head

(75) Inventors: Jerome Cerdan, Beaulieu (FR); Philippe Espinasse, Coudes (FR); Guisseppe Grasso, Le Breuil sur Couze (FR)

Correspondence Address: OSHA LIANG L.L.P., TWO HOUSTON CENTER, 909 FANNIN, SUITE 3500, HOUSTON, TX, 77010, US

(73) Assignee: Valeo Systemes d'Essuyage, La Verriere (FR)

(21) Appl. No.: 11/663,313

(22) PCT Filed: Sep. 13, 2005
(86) PCT No.: PCT/EP05/09798

§ 371 Date: Jan. 23, 2008

(30) Foreign Application Priority Data
Sep. 20, 2004 (FR) 04 09940

(51) Int. Cl. B60S 1/06

(52) U.S. Cl. 15/250.31

(57) ABSTRACT

The invention concerns an arrangement for mounting a single-piece windscreen wiper arm (10) on a head (12) driving the arm (10) in a reciprocating sweeping movement, wherein the arm (10) comprises a first mounting end (10a) which is connected to the driving head (12) so as to transmit the sweeping forces driving the arm (10) and wherein the first end (10a) of the arm (10) is mounted mobile relative to the driving head (12) between a lowered wiping position wherein the blade is pressed against the glass pane and a raised position wherein the blade is spaced apart from the glass pane. The invention is characterized in that it comprises means for locking the first end (10a) of the arm (10) in lowered position, which are adapted to change state when a lifting force is exerted on the arm (10), to enable the first end (10a) of the arm (10) to be moved towards the raised position.

The invention proposes an arrangement for mounting a single-piece windscreen wiper arm on a head driving the windscreen wiper arm in a sweeping movement on a windscreen.

The invention proposes more particularly an arrangement for mounting a single-piece windscreen wiper arm with a main longitudinal orientation on a head driving the windscreen wiper arm in a reciprocating sweeping movement,

of the type wherein the windscreen wiper arm comprises

a first mounting end connected to the driving head so as to transmit the sweeping forces of the

a second free end which is capable of bearing a windscreen wiper arm; and wiper blade of a glass pane;

and of the type wherein the first end of the windscreen wiper arm is mounted mobile related to the driving head between a lowered wiping position wherein the wiper blade is pressed against the glass pane and a raised position wherein the blade is spaced apart from the glass pane.

Document U.S. Pat. No. 4,864,676 describes such a single-piece windscreen wiper arm, i.e. manufactured in one piece.

This windscreen wiper arm comprises an intermediate section which is elastically deformable in order to allow a user to raise the wiper blade in relation to the glass pane in order to allow in particular removal of the wiper blade for replacement of the latter.

However, this deformable section only allows limited deformation of the windscreen wiper arm. Therefore, when the user exerts excessive force on the windscreen wiper arm, this is liable to result in irreversible deformation of the windscreen wiper arm, or even its breakage.

The aim of the invention is to propose an arrangement for mounting a windscreen wiper arm allowing limitation of the risks of damaging the windscreen wiper arm when the user exerts excessive force on the arm.

To this end, the invention proposes an arrangement of the type described above, characterised by the fact that it comprises means of blockage of the first end of the arm in the bottom position, which are capable of changing their state when force to raise the second end of the arm is exerted on the latter, the value of which exceeds a predefined threshold, in order to allow displacement of the first end of the arm to the raised position.

According to other characteristics of the invention:

the first end of the arm is locked in the lower position by elastic interlocking of complementary shapes;

the first end of the arm is separated from the driving head when in the raised position;

the windscreen wiper arm comprises means for linking the arm to the driving head, regardless of the position of the first end of the arm in relation to the driving head;

the aforementioned threshold value of the raising force is lower than the value of force applied to the arm resulting in breakage of a section of the arm;

the driving head comprises vertical locking tabs, with the free upper end of each locking tab interacting with an additional horizontal face of the first end of the arm and each of the locking tabs is capable of elastic deformation during displacement of the first end of the arm in relation to the driving head;

the means of locking comprise a clamping element which is mounted mobile in relation to the driving head between an initial position in which the clamping element partially rests on each locking tab in order to limit the extent of deformation of the locking tab and a second position in which the clamping element does not act on the locking tabs.

Other characteristics and advantages of the invention will appear on reading the detailed description which follows for the understanding of which reference will be made to the appended figures among which:

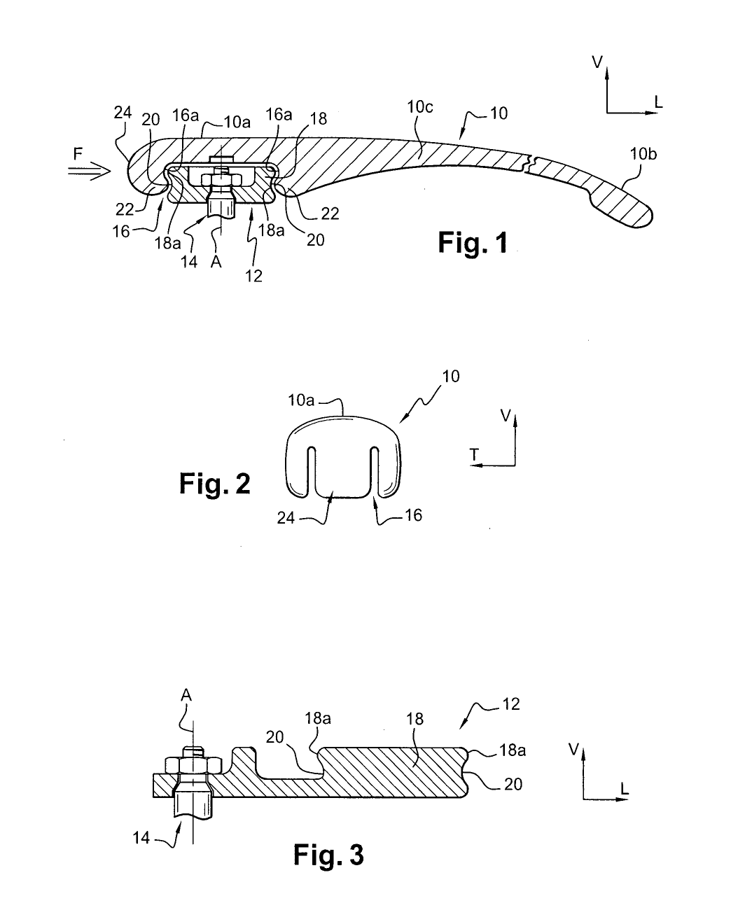

FIG. 1 is a view in longitudinal section of mounting of a single-piece windscreen wiper arm on a driving head according to the invention;

FIG. 2 is an end view along the arrow F of the windscreen wiper arm represented in FIG. 1;

FIG. 3 is a similar view to that of FIG. 1, representing a driving head according to a realisation variant of the invention, for which mounting of the first end of the arm on the driving head is located at an interval from the axis of rotation;

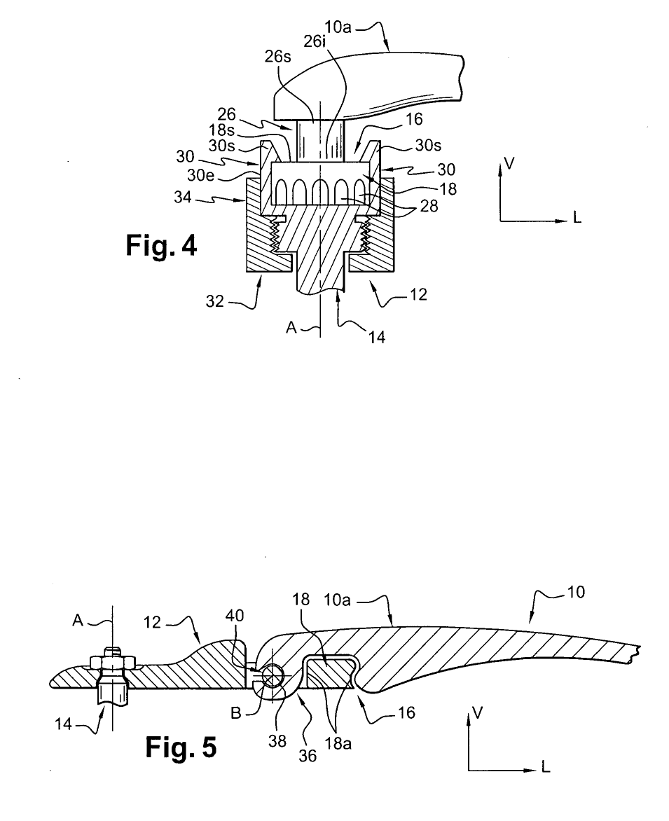

FIG. 4 is a view similar to that of FIG. 1, showing another method of realisation of the arrangement according to the invention in which the first end of the arm is elastically interlocked in the driving head;

FIG. 5 is a view similar to that of FIG. 1, showing a realisation variant of the invention according to which the windscreen wiper arm comprises a tab for permanent linkage of the windscreen wiper arm to the driving head.

For description of the invention, the vertical, longitudinal and transversal orientations according to the mark V, L, T indicated in the figures will be adopted on a non-restrictive basis.

The orientation from front to rear will also be adopted as being the longitudinal direction and from left to right, with reference to FIG. 1.

In the description to follow, identical, similar or analogous elements will be denoted by the same reference figures.

In FIG. 1, a windscreen wiper arm 10 belonging to a wiping mechanism of a glass pane (not illustrated) is shown, particularly a glass pane of a motor vehicle.

The wiping mechanism comprises a driving mechanism of the windscreen wiper arm 10 in a reciprocating sweeping movement in relation to the glass pane.

In this case, and according to a preferred method of realisation, the wiping movement of the windscreen wiper arm 10 involves reciprocating rotation around a vertical axis A globally orthogonal to the plane of the glass pane. It will however be understood that the invention is not limited to this type of sweeping movement, for example, the sweeping involves translation of the windscreen wiper arm parallel to the general plane of the glass pane.

For this purpose, the driving mechanism comprises a drive shaft 14 coaxial to the axis A of rotation of the windscreen wiper arm 10 and a driving head 12 by means of which the windscreen wiper arm 10 is connected to a free end of the drive shaft 14.

The windscreen wiper arm 10 is of the single-piece type, i.e. it is manufactured in one piece. It extends longitudinally overall and comprises a first front longitudinal end which is mounted on the driving head 12, a second free rear longitudinal end 10b which is suitable for carrying a wiper blade (not illustrated) of the glass pane and an intermediate section 10c extending radially overall in relation to the axis of rotation A, between the first end 10a and the second end 10b.

The first end 10a of the wiper arm 10 is mounted mobile in relation to the driving head 12 between a lowered wiping position illustrated in the figures and a raised position.

When it is in the lowered wiping position, the first end 10a of the wiper arm 10 is connected to the driving head 12 in such a manner as to transmit driving forces of the wiper blade 10, which consists in this case of a driving torque around axis A of the drive shaft 14.

Furthermore, when the wiper blade is pressed against the glass pane, the intermediate section 10c of the wiper arm is elastically deformed so that it exerts an elastic force of pressure of the blade against the glass pane.

The elastic deformation of the intermediate section 10c also makes it possible to maintain the blade pressed against the glass pane during the sweeping movement of the windscreen wiper arm 10 around the vertical axis A, regardless of the shape of the glass pane.

When the first end 10a of the windscreen wiper arm 10 is in its raised position, the second end 10b of the windscreen wiper arm 10 and the wiper blade are spaced apart from the glass pane and the intermediate section 10c of the windscreen wiper arm 10 is no longer elastically deformed.

Displacement of the first end 10a of the windscreen wiper arm 10 from its lowered wiping position to its raised position is performed by applying a raising force to the windscreen wiper arm 10 making it possible to separate the second end 10b of the windscreen wiper arm 10 and the wiper blade from the glass pane.

The value of this raising force is greater than a predefined threshold value. Therefore, when the user exerts force on the windscreen wiper arm 10 in order to separate the second end 10b from the windscreen wiper arm 10, the level of which is less than the threshold value, the first end 10a of the windscreen wiper arm 10 remains in its lowered position.

The value of the threshold is determined as a function of the mechanical resistance of the intermediate section 10c of the windscreen wiper arm, in order to avoid breakage of this intermediate section 10c when the user exerts force on the windscreen wiper arm 10 in order to separate the wiper from the glass pane.

When the first end 10a of the windscreen wiper arm 10 is in its raised position, the intermediate section 10c of the windscreen wiper arm 10 is no longer elastically deformed and consequently it no longer exerts any elastic force of return of the second end 10b of the windscreen wiper arm 10 towards the glass pane. This raised position of the windscreen wiper arm 10 is therefore more comfortable for the user who wishes in particular to remove the wiper blade, since the user no longer needs to continue to exert force on the arm 10 in order to keep the latter in the raised position.

According to the invention, the first end 10a of the windscreen wiper arm 10 is maintained in the lowered position by means of locking for as long as the user exerts a force on the windscreen wiper arm 10 in order to separate the wiper blade from the glass pane which is less than the threshold value defined above.

Furthermore, these means of locking are capable of changing state when the user exerts a raising force of a range exceeding the threshold value on the windscreen wiper arm 10. This change in state of the means of locking allows displacement of the first end 10a of the windscreen wiper arm to its raised position.

According to another aspect of the invention, the first end of the arm is blocked in the lowered position by elastic interlocking and interaction of complementary shapes.

According to a first method of realisation of the invention illustrated in FIGS. 1 to 3, the first end 10a of the windscreen wiper arm 10 is separated from the driving head 12 when in the raised position.

In this case, the first end 10a of the windscreen wiper arm 10 delimits a hollow recess 16 which is open downwards that receives a protrusion 18 of the driving head 12.

In order to transmit the sweeping forces driving the windscreen wiper arm 10, the horizontal section of the hollow recess 16 and the horizontal section of the protrusion 18 are non-circular and preferably rectangular or fluted.

The protrusion 18 comprises two opposite transversal vertical walls 18a and each of these vertical walls 18a comprises a transversal throat 20 which receives an additional boss 22 of a vertical wall 16a of the recess 16 located opposite.

The throats 20 and the additional bosses 22 of the protrusion and the hollow recess 16, respectively, effect blocking of the first end 10a of the windscreen wiper arm 10 in the lowered position in relation to the head 12.

The throats 20 and the additional bosses 22 are capable of changing state under the effect of a raising force, in order to allow the protrusion 18 to be withdrawn from the hollow recess 16.

For this purpose, as can be seen in FIG. 2, the first end 10a of the windscreen wiper arm 10 comprises a front tab 24 which bears the boss 22 of the front vertical transversal wall 18a of the hollow recess 16.

This front tab 24 is capable of elastic deformation in order to allow the box 22 to be withdrawn from the associated throat and consequently in order to allow the protrusion 18 to be withdrawn from the hollow recess 16.

The front tab 24 is also capable of deformation during mounting of the first end 10a of the windscreen wiper arm 10 on the driving head 12, i.e. during installation of the protrusion 18 in the hollow recess 16.

According to the method of realisation illustrated in FIG. 1, the protrusion is coaxial to the axis of rotation A of the windscreen wiper arm 10, which makes it possible to limit the total horizontal bulk of the driving head 12.

According to another method of realisation of the driving head 12 illustrated in FIG. 3, the protrusion 18 is radially offset in relation to the vertical axis of rotation A of the windscreen wiper arm 10, rearwards in this case.

Another method of realisation of the invention is represented in FIG. 4 wherein the hollow recess 16 is made in the driving head and the prolongation 18 is borne by the first end 10a of the windscreen wiper arm 10.

The hollow recess 16 is consequently open towards the top.

In this case, the first end 10a of the windscreen wiper arm 10 comprises a lower vertical foot 26 which is coaxial to the axis of rotation A of the arm, the upper end of which 26s is connected to the first end 10a of the windscreen wiper arm 10 and of which the lower end 26i is connected to the protrusion 18.

In order to transmit the driving forces, the prolongation 18 is of cylindrical form and comprises flutings 28 which interact with additional flutings (not illustration) of the hollow recess 16.

The prolongation 18 is maintained in the recess 16 by vertical locking tabs 30.

The upper end 30s of each locking tab 30 is hook shaped and rests on a horizontal upper face 18s of the protrusion 18.

The locking tabs 30 can be elastically deformed in order to allow on the one hand engagement of the prolongation 18 in the hollow recess 16 on mounting the windscreen wiper arm 10 on the driving head 12 and also withdrawal of the prolongation 18 from the hollow recess 16.

This change of state of the locking tabs 30 therefore allows unlocking of the first end 10a of the windscreen wiper arm 10 in the lowered position in relation to the driving head 12.

For this purpose, the locking tabs 30 can be radially deformed towards the outside of the hollow recess 16 so that their free upper ends 30s are displaced away from the vertical axis A.

In order to facilitate engagement of the prolongation 18 in the hollow recess 16, the upper limit 30s of each locking tab 30 is ramp-shaped, comprising an angled support side of a lower edge of the prolongation 18.

According to a realisation variant of the invention allowing limitation of deformation of each locking tab 60 on unlocking the first end 10a of the windscreen wiper arm 10 in the lowered position in relation to the driving head 12, the driving head 12 bears a clamping element 32, with an upper part 34 of the clamping element being situated radially around the locking tabs 30.

The upper part 34 of the clamping element 32 is ring-shaped and is capable of occupying a clamping position illustrated in FIG. 4 in which it rests against the external vertical side 30e of each locking tab 30.

In this clamping position, the upper part 34 of the clamping element 32 rests against a lower part of the external side 30e of each locking tab 30. therefore, when a raising force is applied to the upper end 30s of a locking tab 30, only the upper part of the locking tab which is not in contact with the upper part 34 of the clamping element 32 may deform radially.

The clamping element 32 is mounted mobile in relation to the driving head 12 between the clamping position illustrated in FIG. 4 and a lowered position which is not illustrated in which its upper part 34 is located vertically below the locking tabs 30.

In this case, the link between the locking element 32 and the driving head 12 is a helical-type link.

In its lowered position, the upper part 34 of the clamping element 32 does not rest against the external side 30e of each tab 30; this then allows each of the locking tabs to completely deform when a raising force is applied to the upper end 30s of a locking tab 30.

Consequently, in order to obtain radial displacement of the upper end 30s of a locking tab 30 allowing withdrawal of the prolongation 18 from the hollow recess 16, a greater raising force must be applied to the upper end 30s of each locking tab 30 when the clamping element 32 is in the supper clamping position than when the clamping element 32 is in its lowered position.

Furthermore, it is possible to adjust the threshold value of the raising force to be applied to the windscreen wiper arm 10 for release of the link between the first end 10a of the windscreen wiper arm 10 and the driving head 12 by varying the vertical position of the clamping element 32 on the driving head 12 so that the upper part 34 covers a more or less wide section of the external side 30e of each locking tab 30.

In the methods of realisation of the invention which have been described, displacement of the first end 10a of the windscreen wiper arm 10 in relation to the driving head 12 consists of complete separation of the windscreen wiper arm 10 from the driving head 12.

However, it may occur that a person other than the vehicle owner exerts a raising force on the wiper blade 10 and that this person is ill-intentioned such as to steal the windscreen wiper arm and the wiper blade.

In order to prevent complete separation of the windscreen wiper arm 10 from the driving head 12, the arrangement according to a realisation variant of the invention illustrated in FIG. 5 comprises means of permanent linkage of the windscreen wiper arm 10 to the driving head 12, regardless of the position of the first end 10a of the windscreen wiper arm 10 in relation to the driving head 12.

In this case, the link between the windscreen wiper arm 10 and the driving head 12 is made by means 36 of articulation of the windscreen wiper arm 10 in relation to the driving head 12, around a transversal axis B located longitudinally in front of the protrusion 18.

For this purpose, the first end 10a of the windscreen wiper arm 10 comprises a cylindrical recess 38 with a transversal main axis which is located at the level of the front vertical transversal wall 18a of the hollow recess 16 and which receives in rotation an additional transversal axis 40 of the driving head 16.

It will be understood that the means used in order to keep the windscreen wiper arm 10 connected to the driving head 12 according to the invention are not limited to this method of realisation by an articulation around a transversal axis and the windscreen wiper arm 10 and/or the driving head 12 may comprise other means for connecting the windscreen wiper arm 10 to the driving head 12.

1. Arrangement for mounting a single-piece windscreen wiper arm with a main longitudinal orientation on a head driving the windscreen wiper arm in a reciprocating sweeping movement,
of the type in which the arm comprises:
a first mounting end connected to the driving head so as to transmit sweeping forces of the windscreen wiper arm; and
a second free end which is capable of bearing a wiper blade of a glass pane;
and of the type wherein the first end of the windscreen wiper arm is mounted mobile related to the driving head between a lowered wiping position wherein the wiper blade is pressed against the glass pane and a raised position wherein the blade is spaced apart from the glass pane,
wherein it comprises means of blocking the first end of the arm in the lowered position, which are capable of changing their state when a force to raise the second end of the arm is exerted on the arm, the value of which exceeds a predefined threshold, in order to allow displacement of the first end of the arm to the raised position.

2. An arrangement according to the claim 1, wherein the first end of the arm is blocked in the lowered position by elastic interlocking of complementary shapes.

3. An arrangement according to claim 1, wherein the first end of the arm is separated from the driving head when in the raised position.

4. An arrangement according to claim 1, wherein the arm comprises means of linkage of the arm to the driving head, regardless of the position of the first end of the arm in relation to the driving head.

5. An arrangement according to claim 1, wherein the aforementioned raising force threshold value is lower than the value of a force applied to the arm causing breakage of a section of the arm.

6. An arrangement according to claim 1, wherein the driving head comprises vertical locking tabs, with the free upper edge of each locking tab interacting with an additional horizontal face of the first end of the arm and each of the locking tabs is capable of elastic deformation during displacement of the first end of the arm in relation to the driving head.

7. An arrangement according to claim 1, wherein the means of locking comprise a clamping element which is mounted mobile in relation to the driving head between an initial position in which the clamping element partially rests on each locking tab in order to limit the extent of deformation of the locking tab and a second position in which the clamping element does not act on the locking tabs.

8. An arrangement according to claim 2, wherein the first end of the arm is separated from the driving head when in the raised position.

9. An arrangement according to claim 2, wherein the arm comprises means of linkage of the arm to the driving head, regardless of the position of the first end of the arm in relation to the driving head.

10. An arrangement according to claim 2, wherein the aforementioned raising force threshold value is lower than the value of a force applied to the arm causing breakage of a section of the arm.

11. An arrangement according to claim 3, wherein the aforementioned raising force threshold value is lower than the value of a force applied to the arm causing breakage of a section of the arm.

12. An arrangement according to claim 4, wherein the aforementioned raising force threshold value is lower than the value of a force applied to the arm causing breakage of a section of the arm.

13. An arrangement according to claim 2, wherein the driving head comprises vertical locking tabs, with the free upper edge of each locking tab interacting with an additional horizontal face of the first end of the arm and each of the locking tabs is capable of elastic deformation during displacement of the first end of the arm in relation to the driving head.

14. An arrangement according to claim 3, wherein the driving head comprises vertical locking tabs, with the free upper edge of each locking tab interacting with an additional horizontal face of the first end of the arm and each of the locking tabs is capable of elastic deformation during displacement of the first end of the arm in relation to the driving head.

15. An arrangement according to claim 4, wherein the driving head comprises vertical locking tabs, with the free upper edge of each locking tab interacting with an additional horizontal face of the first end of the arm and each of the locking tabs is capable of elastic deformation during displacement of the first end of the arm in relation to the driving head.

16. An arrangement according to claim 5, wherein the driving head comprises vertical locking tabs, with the free upper edge of each locking tab interacting with an additional horizontal face of the first end of the arm and each of the locking tabs is capable of elastic deformation during displacement of the first end of the arm in relation to the driving head.
